(19) United States
(12) Patent Application Publication
(10) Pub. No.: US 2012/0288588 A1
(43) Pub. Date: Nov. 15, 2012

(54) FUNCTIONAL CEREAL FORMULATION

(76) Inventor: Jon Barron, Chatsworth, CA (US)

(21) Appl. No.: 13/445,615

(22) Filed: Apr. 12, 2012

Related U.S. Application Data
(60) Provisional application No. 61/485,519, filed on May 12, 2011.

(51) Int. Cl. A23L 1/164; A23L 1/308; A23L 1/18; A23L 2/66; A23P 1/12; A23L 1/302; A23L 1/304; A23L 1/303

(52) U.S. Cl. 426/73; 426/72; 426/590; 426/621; 426/620

(57) ABSTRACT

Nutritional or functional food compositions comprise a combination of brown rice protein isolate, yellow pea protein isolate, and hemp protein isolate. The food compositions are hypoallergenic and highly bioavailable. Methods of making suitable RTD formulations are described.

This application claims the benefit of earlier filed U.S. Provisional Application No. 61/485,519, filed on May 12, 2011, which is hereby incorporated by reference herein.

### FIELD OF THE INVENTION

A hypoallergenic, high-protein cereal or functional food composition comprises a combination of brown rice protein isolate and/or yellow pea protein isolate and/or hemp protein. Embodiments of the formulation include ingredients balanced in a synergistic manner to elicit complementary effects which provide hypoallergenic high-protein supplementation for increasing muscle mass in athletes, and providing unmet dietary requirements in children, reversing muscle wasting in senior citizens and active adults, speeding up wound care healing in long-term acute care facilities (LTACs), and use as meal replacement programs for the facilitation of weight loss. Methods of making suitable functional formulations are described.

### BACKGROUND

Getting sufficient protein in the diet is difficult for many types or classes of people, i.e., populations and sub-populations, demographically speaking. Athletes can require over 100 g of protein a day. Children are often allergic to many forms of protein, specifically dairy, soy, nut, and egg protein. In senior citizens, these same allergies may return even stronger than in childhood, and that, coupled with a reduced appetite, and/or lower testosterone levels, results in the muscle wasting so commonly seen in the elderly. Dietary sources of protein are often inefficient and/or insufficient to meet the needs of a given sub-population of individuals.

Meat, for example, is only about 20% protein by weight, which requires you to eat 5 g of meat for every 1 g of protein ingested. Dietary sources also often come with health consequences such as high levels of saturated fat that make their use in high quantities questionable. However, a recent clinical study at University of Texas Medical School at Galveston found that ingestion of moderate and high quality available protein will increase muscle mass or slow muscle loss in a patient of any age (Symons, et al., J. Am. Dietetic Assoc. 2009 Sep. 9: 1582-1586). Such findings can serve as a critical factor in maintaining seniors' health, among others. Therefore, using supplemental sources of protein having high protein content is often required to obtain sufficient levels for health.

As mentioned, many people have allergies to the primary sources of supplemental protein such as dairy, soy, and egg. In fact, according to the Food Allergen Labeling and Consumer Protection Act of 2004 (FALCPA), food manufacturers are required to identify all ingredients in a food product containing one or more of the eight major food allergens (i.e., milk, eggs, fish, shellfish, tree nuts, wheat, peanuts, and soybeans). According to FALCPA, these eight foods are believed to account for 90 percent of food allergies and most serious reactions to foods. Seven of the eight allergens are used as protein sources, and these particular proteins are the primary source of allergens in the human body. By definition, then, consumption of concentrated sources of the standard supplemental proteins (dairy, whey, soy, nut and egg) typically cause many people to complain about bloating, gas, acne, constipation, and cramping, among other deleterious symptoms and side-effects. Because whey is a concentrated form of dairy, many consumers with even a slight dairy allergy will experience an adverse reaction. It would be desirable to provide a protein supplement formulation or cereal product that is 100% hypoallergenic.

Brown rice protein, yellow pea protein, and hemp protein are all identified as hypoallergenic. That means that unlike dairy, soy, or nuts (the standard protein additives in functional foods), they are unlikely to produce an allergic response in the human body. Brown rice protein, yellow pea protein, and hemp protein are excluded from “allergenic” FDA-designated categories.

The present inventor pioneered the use of a rice protein and yellow pea protein combination in mixable powders. But consumers, whether among the general population or as patients, have a reluctance to use powders. Most protein powder products are not self contained, requiring the addition of water or juice and fruit to blend into drinks or smoothies. Thus, powders may not be convenient for an individual to use in office environments or at the gym. They are also not easily distributed in schools, institutions, hospital or senior community environments where meals are prepared in a central kitchen and subsequently delivered to consumers. However, consumers may still use a powder in a situation where the advantages and beneficial effects of the powdered product outweigh comparatively minor inconveniences, e.g., in a home kitchen arrangement.

In view of the above, there is a need and a desire for dietary high protein supplements and/or functional food including combinations of brown rice protein, yellow pea protein, and hemp protein that exploit the potential beneficial properties of these components in a readily bioavailable, consumer friendly, edible and easily consumed formulation.

### SUMMARY OF THE INVENTION

In one embodiment, the invention relates to high protein hypoallergenic breakfast cereal comprising a protein isolate blend incorporating a brown rice protein isolate, a yellow pea protein isolate, and a hemp protein isolate.

In a further embodiment, a formed food composition is provided comprising a protein isolate blend including a rice protein isolate, a yellow pea protein isolate, and a hemp protein isolate in combination with a nutraceutically acceptable carrier having a form selected from a cereal piece, chip, flake, cluster, puff, sphere, ribbon, biscuit, chex-like shape, and O-shape.

In another embodiment, a hypoallergenic dietary supplement composition comprising a protein isolate blend includes a rice protein isolate, a yellow pea protein isolate, and a hemp protein isolate in combination with a nutraceutically acceptable carrier and an edible liquid in a ready-to-drink (RTD) formulation.

Also provided is a method for incorporating the combination of rice, yellow pea, and hemp protein in ready-to-drink (RTD) beverages, baked goods, and snacks—all with the purpose of delivering significant levels of hypoallergenic protein in easy to use, consumer friendly products, as opposed to mixable protein powders, as they are often not consumer friendly.

### DETAILED DESCRIPTION

A nutritional composition comprising a complementary combination of brown rice protein, yellow pea protein, and hemp protein has been discovered. The inventive composition, which does not include any of the eight major food allergens (either singly or in combination), is substantially, generally, and/or completely hypoallergenic and specifically contains no dairy, soy, nuts, or eggs.

In addition, there is a unique advantage in using a brown rice, yellow pea, and hemp protein blend in the embodiments of the invention. Use of the three components singularly may not produce the desired optimized balance of amino acids, nor the high Protein Efficiency Ratio (PER) found in the combination.

Rice protein contains high levels of cysteine and methionine, but tends to be low in lysine. Yellow pea protein, on the other hand, tends to be low in the sulfur containing amino acids, cysteine and methionine—but contains high levels of lysine. And additionally, because hemp protein is comprised of primarily edestin and albumin, two of the most common types of proteins found in the human body, it is very easy to digest and assimilate. The end result is that when used in combination, rice protein, yellow pea protein, and hemp protein, in a complementary and synergistic way, generally offer a Protein Efficiency Ratio that begins to rival dairy and egg—but without their potential to promote allergic reactions.

For the purposes of the present disclosure, and as used herein, Protein Efficiency Ratio (PER) is based on the weight gain of a test subject or individual divided by the subject's intake of a particular food protein or protein blend during a given testing or training period.

PER=gain in body mass (g)/protein intake (g). Equation (1)

The advantageous effects of the invention can be achieved by combining a brown rice hypoallergenic protein material, a yellow pea hypoallergenic protein material, and a hemp hypoallergenic protein material in easily distributed and easily consumed functional foods. One useful functional food delivery system includes cold cereal, which is generally and optionally eaten at room temperature right out of the package, with or without a companion liquid such as milk. Other delivery systems include, but are not limited to, pre-packaged ready-to-drink (RTD) beverages, baked goods, and snacks.

In one embodiment, use of a combination of a brown rice protein material, a yellow pea protein material, and a hemp protein material in functional foods allows for the easy delivery and effortless consumption of large amounts of hypoallergenic protein.

In another embodiment, use of a combination of a brown rice protein material, a yellow pea protein material, and a hemp protein material in functional foods allows for the delivery of large amounts of hypoallergenic protein in such a manner that is generally and virtually unmatched by any other protein source currently available. A primary advantage in this invention is that unlike dairy, soy, and nuts (the primary protein sources used in functional foods) brown rice, yellow pea, and hemp proteins, and protein materials and/or blends derived therefrom, are hypoallergenic.

In contrast, dairy products are allergenic. When most people think of dairy allergies they think of lactose intolerance. Lactose intolerance, however, is not an allergy, in that it is not based on an immune response. It is the result of the body losing the ability to produce the enzyme lactase, which is required for the digestion of the milk sugar, lactose. Although, technically not an allergen, the result of lactose intolerance is virtually indistinguishable from an actual allergy. Symptoms include gas, diarrhea, and bloating. Yet another advantage of the present invention is that brown rice protein and yellow pea protein contain no lactose.

The primary allergens in dairy are actually casein, alpha-lactalbumin, and beta-lactaglobulin (Järvinen, et al., Int. Arch. Allergy Immunol. (2001) 126(2): 111-118). Although casein is removed from most whey products, it is at the expense of an increased concentration of alpha-lactalbumin and beta-lactaglobulin. In addition, the problem of allergens in dairy is exacerbated with the application of heat, either through pasteurization or processing in the manufacture of functional foods. Heat denatures the allergenic proteins, fundamentally altering their structure so that their uptake by the body is pushed away from intestinal epithelial cells and redirected to Peyer's patches, which can promote significantly higher Th2-associated antibody and cytokine production (Roth-Walter, et al., Allergy (2008) 63(7):882-890).

Soy protein is also allergenic. The first allergic reactions to soy in humans were described in 1934 by Duke, J. Allergy (1934) 5:300-302. Anti-soy IgE antibodies have been identified, but allergen specificity patterns are variable and complex. As many as 28 soy proteins bind to IgE in soy-allergic patients (Awazuhara, et al., Clin. Exp. Allergy (1997) 27(3):325-332).

Nut proteins are also allergenic. Concern over nut allergies reached a fever pitch in the mid-2000's when some schools instituted some severe restrictions on the use and consumption of nuts. At a San Francisco elementary school, for example, a nurse was assigned to ensure that the children scrubbed their hands as they arrived, while their packed lunches were confiscated and searched for nut products. These extreme measures were a precaution to protect a 5-year-old boy at the school who had a severe nut allergy. At another school, a school bus full of 10-year-olds was evacuated after a stray peanut was found on the floor. Although such responses are excessive, these anecdotal accounts illustrate that nut proteins are definitely a well known source of allergens, which makes their use as a protein source in functional foods less than optimal (Ewan, P. W., Brit. Med. J. (1996) Apr. 27; 312 (7038):1074-1078).

Dairy is at present the primary supplemental source of protein in protein-boosting RTD's.—e.g., Boost®, Ensure®, and MyoPlex® Lite (MyoPlex® Lite actually includes a blend of dairy and soy proteins). Soy is the primary source of supplemental protein in high protein breakfast cereals—Kashi® Golean Crunch!®, Kashi® Golean®, and Kellogg's® Special K® Protein Plus. Nuts, along with soy, are a primary source of supplemental protein in high protein food bars. The protein sources used in all these functional food products are accordingly known to be allergenic.

Celiac disease is caused by an aberrant non-IgE mediated immune response to dietary glutens found primarily in wheat grains. The prevalence of the disease in the United States is estimated to be a little less than 1% of the population. Technically, as used herein, “gluten” is a term specifically applied to the combination of prolamin proteins and glutelin proteins (gliadins and glutenins, respectively) found in wheat. Although all cereal grains contain prolamin and glutelin proteins, these proteins are not identical in different grains. The US FDA defines allergenic wheat as any species in the genus Triticum. Cereal grains presumed to be safe for persons with celiac disease include amaranth, buckwheat, corn, millet, quinoa, ragi, rice, sorghum, teff, and wild rice. The prolamins in other cereal grains (e.g., zein in corn, and orzenin in rice) have been shown not to affect individuals with celiac disease.

The protein blends and/or food compositions in certain embodiments prepared according to the principles of the present invention may be considered as generally or substantially “gluten-free.”

In light of the above discussion, one can recognize deficiencies in many known protein-containing products for allergic individuals or those susceptible to allergies. Also of current concern are wheat protein-containing products for individuals suffering from celiac disease. Additionally, dairy protein-containing products are a concern for individuals suffering from lactose intolerance or allergies to casein, and alpha and beta lactalbumin.

Brown rice protein, yellow pea protein, and hemp protein as used herein are each identified as hypoallergenic. That means that unlike dairy, soy, or nuts (the standard protein additives in functional foods), they are unlikely to produce an immune-mediated allergic response in the human body. Hemp protein, although it comes from a seed, is considered to be hypoallergenic. As used herein, the term “hypoallergenic” means a chemical compound, bioactive substance, or food ingredient that does not produce an immune-mediated allergic response in an individual.

In contrast, the hypoallergenic embodiments of the invention described herein provide a clear advantage as a supplemental source of protein in high protein functional foods. By using rice protein, yellow pea protein, and hemp protein in combination, in one embodiment the invention offers a better amino acid profile and more bioavailability than by using any of the protein sources alone. Also, in another embodiment, in addition to being hypoallergenic and offering a superior amino acid profile, the invention offers a number of other health benefits as compared to other protein sources.

The following additional benefits may be realized by using the inventive combination of rice protein, yellow pea protein, and hemp protein incorporated into a nutritional composition in accordance with the embodiments of the present invention.
a. Gastroileal absorption of pea protein has been actually measured at an astounding 89%. The absorption is correlated with a significant increase in blood levels of amino acids and nitrogen levels, a primary marker of protein utilization (Gausseres, et al., J. Nutr. (1997) vol. 127, no. 6, 1160-1165).
b. A study on the effect and mechanism of rice protein on cholesterol and triglyceride metabolism compared to casein and soy protein, in rats, shows that rice protein has cholesterol-lowering effects in the plasma and the liver that is comparable to soy protein, and the effects were accompanied by triglyceride-lowering effects in the liver (Yang, et al., Bioscience, Biotechnology, and Biochemistry (2007), Vol. 71, No. 3, 694-703).
c. A study suggests that diets high in rice protein can help protect against atherosclerosis by increasing blood levels of nitric oxide (Ni, et al., Br. J. Nutr. (2003) 90(1):13-20).
d. Another study demonstrated that a rice protein isolate altered 7,12-dimethylbenz[a]anthracene-induced mammary tumor development in female rats (Morita, et al., J. Nutr. Sci. Vitaminol. (Tokyo) (1996) 42(4):325-337).
e. A study on the hypertensive activity of rice protein found that it had the ability to reduce blood pressure (Li, et al., Asia Pac. J. Clin. Nutr. (2007) 16 (Suppl 1):275-280).
f. Rice protein isolate has been reported to prevent the development of heart disease and to improve body composition by reducing % body fat content in rats fed a rice protein source during development (Ronis, et al., FASEB J. 20(4):A1015).
g. Hemp protein has been proven to be highly digestible with high bioavailability. (House, et al., J. Agric. Food Chem. 2010, 58 (22): 11801-11807).
h. Hemp protein consists of two globular proteins, albumin (ca. 33%) and edestine (or, edestin) (ca. 67%), with a structure very similar to proteins manufactured in human blood and is thus readily digestible. Hemp protein contains all of the essential amino acids in nutritionally significant amounts and at ratios close to that of other “complete” sources of protein (such as meat, milk, and eggs). In addition, hemp protein appears to be free of antinutrients that are found in soy to interfere with protein uptake. (Leson, The Vote Hemp Report (2002/2003) pp. 12-13, Ed. E. Steenstra, Vote Hemp, Inc., Merrifield, Va.).
i. And finally, rice, pea, and hemp protein do not contribute to aminoacidemia, as does whey (Boirie, et al., PNAS (1997) vol. 94, no. 26, 14930-14935). In fact, for years, bodybuilders have consumed whey in a deliberate attempt to force their bodies into a state of aminoacidemia because it was assumed to be the best way to keep the body in a positive nitrogen state and promote muscle growth. New studies, however, indicate that this bodybuilding technique may actually be counterproductive (Lacroix, et al., Am. J. Clin. Nutr. November 2006, vol. 84, no. 5, 1070-1079). But even worse, aminoacidemia may actually have negative long term health consequences. One such negative example is diabetes. Interestingly enough, short term aminoacidemia can actually lower blood sugar levels since it stimulates higher beta-cell secretion and a concomitant increase in insulin levels by as much as 40% (Tessari, et al., Diabetes/Metabolism Research and Reviews July/August 2007, Volume 23, Issue 5, pages 378-385). This, of course, significantly lowers blood sugar levels. However, over time, this constant stimulation may overstress and degrade the ability of beta-cells to produce sufficient insulin when called for and may ultimately, over time, contribute to undesirable pre-diabetic and diabetic conditions in the body (Sako, et al., Diabetes (1990) 39(12): 1580-1583).

The high protein embodiments made in accordance with the present invention can include cereals and ready-to-drink formulations (RTD's). In a cereal embodiment, an effective formulation comprises a brown rice protein isolate, a yellow pea protein isolate, brown rice flour, a hemp protein isolate, oat fiber, and an all natural vitamin/mineral mix.

Useful rice protein isolates include Oryzatein™ protein isolate (above 90% protein), available from Axiom Foods, Los Angeles Calif. and Brown Rice Protein Powder from AG Commodities, Tustin, Calif. Useful rice protein concentrates include Oryzatein™ organic brown rice protein powder at 70% and 80% protein concentrate levels, available from Axiom Foods, Los Angeles Calif.

Useful pea protein isolates/concentrates include NUTRALYS® pea protein, approx. 85% protein, available from Roquette America, Inc., Keokuk, Iowa, or VegOtein P™ protein at 50%, 75%, and 80% protein isolate/concentrate levels, available from Axiom Foods, Los Angeles Calif., and Propulse Pea Protein from Norben Company, Willoughby, Ohio.

Useful vitamin mixes can be custom blended by Fortitech, Ontario, Calif.

Brown rice flour is available from Honeyville Farms, Rancho Cucamonga, Calif.

In an embodiment, the cereal or cereal piece(s) can be formed using an extrusion process, into a variety of consumer-preferred shapes such as, but not limited to: flakes, ribbons, “chex” or “chex-like,” biscuits, or O-shapes (such as, e.g., “O's”). Other useful baked or puffed shapes include, but are not limited to: puffs, spheres, clusters, and the like. Extrusion cooking methods are well known in the art.

Other methods for making the inventive cereal or cereal piece(s) may include baking, kneading, sheeting, toasting, roasting, frying, rolling, lamination, cold-processing, or combinations or variants thereof. These exemplary processes can produce baked product items such as cookies, bars, biscuits, crackers, and the like.

In an RTD embodiment, an effective formulation can optionally include citrulline malate to promote aerobic energy production in human exercising muscle and/or limit muscle fatigue; to protect against acidosis and ammonia poisoning, and accelerate the clearance of ammonia. Another altenative RTD embodiment can also include conjugated linoleic acid (CLA) and/or propolmannan to assist in weight loss, and L-Carnosine and acetyl-L-Carnitine to protect muscle tissue, for example, in the elderly.

Components Contained in the Cereal Formulation

The protein components useful in certain nutritional formulation embodiments can include purified proteins, protein isolates or hydrolysates, and blends or mixtures thereof. Protein concentrates are also contemplated to be useful in certain nutritional formulation embodiments.

Rice Protein

Standard cooked rice has a protein content of only about 5%-7%. To make concentrated rice protein, whole brown rice is ground into flour, then is mixed with water to form a thick slurry in a process called liquefaction. Natural enzymes as are well known in the art are then added sequentially to break down and separate out the carbohydrates and fibers from the protein portion of the slurry. Since the process is enzyme based, temperature must be kept below about 90° F. (32° C.) to preserve the enzyme activity levels. Low temperature and chemical free processing prevent the denaturing of amino acids, as is frequently seen in soy and dairy processing. Final stage processing includes filtering, drying, and low temperature milling using standard methods. The end product is 80-90% pure, hypoallergenic, and easily digested protein. Advantageously, this processed brown rice protein is relatively soluble and/or suspendible, and can be mixed easily into water, juice, or other food preparations, for example.

After four hours, the body digests over 86% of all ingested rice protein, compared with about 57% for soy. In the end, rice protein has a biological value of between 70-80, a net protein utilization of about 76, and a digestion efficiency of some 98%.

Good sources of brown rice protein/rice flour include: whole grain brown rice flour, Oryzatein™ organic brown rice protein concentrate having a protein content of 70% and 80% by weight protein and Oryzatein™ organic brown rice protein isolate having a protein content of greater than 90% by weight protein, all available from Axiom Foods, Los Angeles Calif. Brown rice flour is milled brown rice, that has not been processed in any way to concentrate protein

It is noted that rice protein is high in the amino acids cysteine and methionine, but tends to be low in lysine, which negatively impacts its bioavailability. If lysine levels can be raised in the purified protein components or protein blends, bioavailability of the overall protein and amino acids, and utilization of overall amino acids, will be dramatically increased.

Yellow Pea Protein

When it comes to consumer perception, more people have a problem with the “idea” of peas and pea protein than with rice protein. In fact, pea protein has a very mild, pleasantly sweet taste. It is regarded as one of the better tasting proteins. Yellow pea protein comprises the concentrated natural protein fraction of yellow peas. The process used for concentrating yellow pea protein is enzyme- and water-based, similar to that used for concentrating rice protein as discussed above, making the end product very “natural.”

Yellow peas and green peas are different varieties of the same plant (Pisum sativum). The yellow pea is preferred for use in protein extraction both because of its milder, sweeter taste and unobtrusive color. Green tinged protein would be less desirable in most food applications. Thus, other pea proteins are contemplated as useful in embodiments of the present invention. Yellow pea proteins are preferred, although other useful pea proteins and pea protein isolates can be derived from the following edible seeds. Split peas are the dried, peeled and split seeds of Pisum sativum. As mentioned these come in yellow and green varieties. The peas are round when harvested and dried. Once dry, the skin is removed and the natural split in the seed's cotyledon can be mechanically separated, in part to encourage faster cooking Green and yellow split peas are commonly used to make pea soup, for example. Peas are often eaten “green,” that is while they are immature and right after they are picked. Thus, useful pea varieties include, but are not limited to, green peas, garden peas, English peas, snow peas, snap peas, and the like. One useful source of yellow pea protein is Nutralys® pea protein, 85% concentrated protein source available from Roquette America, Inc., Keokuk, Iowa.

Hemp Protein

Hemp has a superior protein structure including ca. 66% edestin and 33% albumin. Edestin in particular is a globular protein which is easily digested, absorbed, and utilized by the human body. As a side note, it closely resembles the globulin found in human blood plasma, which is vital to maintaining a healthy immune system. As such, edestin possesses the unique ability to stimulate the manufacture of antibodies against antigens and other exogenous proteins or foreign organisms. Like rice protein and yellow pea protein, hemp protein is also hypoallergenic.

Hemp seeds can be ground up to change their consistency, but are essentially the first stage of processing. Whole hemp seeds are squeezed through a screw press to extract substantially all of the oil out of the seed. The remaining material is called hemp seed cake. This seed cake is milled and turned into powder. The powder is then sifted/screened. The product of this initial sift is hemp flour, a high fiber but lower protein material. To make hemp protein, the powder is sifted/screened to a finer degree. This removes more of the fiber leaving a higher concentrate of protein. Food grade ethanol or enzymes, or a combination of both, may then be used as an extracting solvent. This maximizes the final protein content while minimizing the final fat content. When 95% ethanol is used in a double solvent extraction process (1 hour +1 hour), the fat content of the hemp meal can be reduced to below 1%, thus concentrating the protein remaining in the powder to greater than about 58%. Even higher concentrations can be achieved using a higher extraction pH of around 11 and a precipitation pH of 6.5. High grade 70% hemp protein is now commercially available, for example, Hemp Pro 70 hemp protein concentrate (70% protein by weight) (available from Manitoba Harvest Hemp Foods & Oils, Winnipeg, Manitoba, Canada). For the purpose of this disclosure, the hemp protein concentrate is considered to be a “hemp protein isolate.” It is understood that hemp protein concentrates and/or isolates are readily available having concentrations by weight ranging from about 50% by weight protein to about 90% by weight protein, or greater.

Hemp has been used through history to create many all-natural products since its fibers are among the strongest of any plant. Hemp is also extremely easy to grow, takes a low toll on the soil, and can be replanted over and over again. Although hemp shares the same Latin name as marijuana (Cannabis sativa), hemp comes from the male cannabis plant, which contains virtually no psychoactive tetrahydrocannabinol (THC). It is not really possible for a human to generate a drug-induced high by smoking the parts of the hemp plant, even if a vast quantity were consumed.

The Inventive Combination: rice, yellow pea, and hemp proteins.

Blends of rice protein isolate, yellow pea protein isolate, and hemp protein isolate are contemplated.

In an embodiment, the ratio (among the protein isolates) of rice protein to pea protein to hemp protein is about 1:5:4 wt/wt/wt, based on total protein. In another suitable embodiment, the ratio (among the protein isolates) of rice protein to pea protein to hemp protein is about 2:4:4 wt/wt/wt, based on total protein. Given a total weight value of 10, the ratio can range up to 8 parts for the highest protein and 2 parts for the other two proteins combined. The ratio may be determined by the requirements of the specific application. For example, because of its nutty flavor, hemp protein would work well at a high ratio in cereal, where a nutty taste would be a plus, but would have to be at a very low ratio in a vanilla flavored RTD, where the nutty taste would be viewed as unappealing. In an alternative embodiment, the ratio (among the protein isolates) of rice protein to pea protein to hemp protein is about 1:4:4 wt/wt/wt, based on total protein.

Suitably, the blend can include a rice protein isolate present in a range of from about 1 g to about 15 g per serving, a yellow pea protein isolate present in a range of from about 1 g to about 15 g per serving, and a hemp protein isolate present in a range from about 1 g to about 15 g per serving. It is to be understood that protein “isolates” may have purity levels or concentrations that are generally high, in the range of about 70-90% by weight protein, or greater. These isolates may also be referred to as protein “concentrates,” as described herein. However, the protein levels that occur in protein isolates may vary, as is generally understood by those having skill in the art.

One suitable formulation comprises a cereal (50 g per serving) having brown rice protein isolate in an amount from about 1 g to about 12 g per serving, in combination with yellow pea protein isolate in an amount from about 3 g to about 15 g per serving, and further in combination with hemp protein isolate in an amount from about 3 g to about 15 g per serving, and a grain oriented base. In another suitable embodiment, the cereal may include hemp protein isolate in an amount from about 3 g to about 12 g per serving. Optionally, the cereal can include added natural fiber and naturally sourced vitamins and/or minerals to provide a balanced nutrition, hypoallergenic, high protein meal.

As mentioned previously, rice protein is high in cysteine and methionine, but tends to be low in lysine. Yellow pea protein, on the other hand, tends to be low in the sulfur containing amino acids, i.e., cysteine and methionine—but high in lysine. In a complementary way, hemp protein is comprised of primarily edestin and albumin, two of the most common types of proteins found in the human body and, thus, very easy to digest and assimilate. As discussed above, hemp is also a source of complete protein. For example, in comparison to soy protein, hemp protein contains a higher level of methionine, a lower level of lysine, and similar levels of other essential amino acids. When used in an advantageous combination as disclosed herein, rice protein, yellow pea protein, and hemp protein offer a Protein Efficiency Ratio that begins to rival dairy and egg products, yet without the known potential of dairy and egg products to induce or promote allergic reactions. In addition, the texture of yellow pea protein and hemp protein help smooth out the chalky quality, or “chalkiness” of rice protein. All three proteins are hypoallergenic and easily digested.

The rice/yellow pea/hemp protein combination also has an effective branched-chain amino acid (BCAA) profile, which is far better than soy, and only slightly less so than whey. Table 1 shows a comparison of BCAA components in whey vs. rice/yellow pea/hemp protein mix.

TABLE 1

| | | Rice/Yellow | Rice/Yellow |
|---|---|---|---|
| | | Pea/Hemp 1:2:2 | Pea/Hemp 1:4:4 |
| | Whey | wt/wt/wt protein | wt/wt/wt protein |
| | protein | combination | combination |
| Leucine (wt. percent | 8 | 8 | 7 |
| of total) | | | |
| Isoleucine (wt. percent | 6 | 4 | 4 |
| of total) | | | |
| Valine (wt. percent | 5 | 5 | 5 |
| of total) | | | |

In accordance with another embodiment, a hypoallergenic, high-protein RTD dietary supplement composition comprising a rice protein isolate, a yellow pea protein isolate, and a hemp protein isolate may be prepared. See, Example 3A.

Advantages of the RTD embodiment include high levels of consumer acceptance and ease of use. RTD's are particularly useful in community settings, where people are fed from a central commissary such as retirement communities or acute care centers. Seniors, in particular, are often protein deficient as a result of reduced appetite and/or a reduced ability or an inability to tolerate the standard sources of concentrated protein such as dairy and soy. A highly concentrated, hypoallergenic protein source that could be simply added to a resident's food tray as part of their daily meals, would be particularly advantageous.

RTD's would also be advantageous for homebound seniors, who might be incapable, or unlikely, to want to blend up powders in a smoothie. Surveys have shown that a large proportion of the elderly eat below the adult recommended dietary allowance (RDA) for protein, with the lowest amount being consumed by the homebound elderly. A report in the October 1994 American Journal of Clinical Nutrition, Campbell, et al., (1994) 60:501-509, found that elderly people may actually have a higher protein requirement than other adults. Such research raises serious questions as to whether a chronic protein deficiency may be contributing to the decline of the elderly. Also, rapid delivery of the proteins can be achieved resulting in rapid absorption by the body.

In accordance with another embodiment, a method of making a hypoallergenic, high-protein RTD dietary supplement composition comprising a rice protein isolate, a yellow pea protein isolate, and a hemp protein isolate is provided. See, Example 3B.

Also contemplated in the embodiments of the present invention is the addition of other suitable and advantageous or complementary herbs, herbal extracts, and nutraceuticals. The addition of other herbal extracts and nutraceuticals can add other beneficial effects, or help to increase or decrease the beneficial effects further in a desired direction. In addition, added herbal extracts and nutraceuticals can be used to balance strong beneficial effects, such as mental alertness and acuity with relaxation and anxiolytic properties. For example, the addition of citrulline malate would make the invention more suitable for athletes, whereas the addition of conjugated linoleic acid (CLA) and/or propolmannan would make the product more suitable for those individuals looking for weight management options. Optionally, the addition of L-Carnosine, acetyl-L-Carnitine, and/or dimethylaminoethanol (DMAE) would optimize the product for senior citizens as it would protect against damage to muscle and organ proteins, a cumulative problem in the elderly.

Delivery System

Suitable methods of administration include, but are not limited to, sublingual, buccal, oral, and the like.

Suitable dosage forms include tablets, capsules, solutions, suspensions, powders, gums, and confectionaries. Other sublingual delivery systems include, but are not limited to, dissolvable tabs under and on the tongue, liquid drops, and beverages. Edible films, hydrophilic polymers, oral dissolvable films or oral dissolvable strips can be used.

Beverage embodiments are contemplated with flavor enhancements and/or various flavors added, as appropriate. This will be particularly appealing to the institutional market in which meals are served on trays, which means that a self-contained, self-serving, less spillable, RTD in a can or Tetra Pak is far more appealing than a protein powder requiring mixing and serving in a glass.

Liquid-based nutritional or dietary supplement compositions for oral administration can be prepared in water, juices, or other aqueous vehicles. Useful liquid forms include solutions, suspensions, emulsions, and the like. Microemulsions and microencapsulations are contemplated. In addition to the above enumerated ingredients or compounds, liquid nutritional compositions can include suspending agents such as, for example, methylcellulose, alginates, tragacanth, pectin, kelgin, carrageenan, acacia, polyvinylpyrrolidone, polyvinyl alcohol, and the like. The liquid nutritional or dietary supplement compositions can be in the form of a solution, emulsion, syrup, gel, or elixir including or containing, together with the above enumerated ingredients or compounds, wetting agents, surfactants, dispersants, emulsifiers, sweeteners, and coloring and flavoring agents. Various liquid and powder nutritional compositions can be prepared by conventional methods.

The nutritional and dietary supplement compositions may or may not be presented in unit dosage forms and/or servings, depending on the delivery system and/or the end user. Unit dosage, for example, would be applicable to an RTD delivery system. In such form, the preparation is subdivided into unit doses containing appropriate quantities of the nutritional or active component(s). The unit dosage form can be a packaged preparation, the package containing discrete quantities of preparation. Food bars and biscuits are likewise amenable to unit dosage servings. Cereals and pastas, on the other hand, would work well in unit dosage forms in an institutional setting, but would work better in a multi-serving bulk box for home use, where cost savings would likely outweigh convenience factors. A serving can be in the form of a multiplicity of baked cereal pieces, crisps, or puffs, or in the form of a variety of pastas. The serving form can be a packaged preparation, the package containing discrete pieces, such as packaged cereal pieces, crisps, or puffs, or it can be the appropriate number of any of these in packaged form. One useful serving can be dry volume measures as used in baking, such as, for example, ½ cup or 1 cup.

The edible components may be combined with one or more solid inactive ingredients or excipients for the preparation of cereal pieces, chips, flakes, clusters, puffs, spheres, ribbons, biscuits, bars, gum pieces, tablets, capsules, pills, powders, granules or other suitable edible dosage forms. For example, the active agent may be combined with at least one excipient such as fillers, binders, humectants, disintegrating agents, solution retarders, absorption accelerators, wetting agents, surfactants, dispersants, emulsifiers, absorbents, or lubricating agents. Other useful excipients include magnesium stearate, calcium stearate, mannitol, xylitol, sweeteners, starch, carboxymethylcellulose, microcrystalline cellulose, silica, gelatin, silicon dioxide, and the like. Other useful excipients include: carrier materials such as starch, gelatin, acacia, microcrystalline cellulose, kaolin, dicalcium phosphate, calcium carbonate, sodium chloride, alginic acid, and the like; disintegrators including microcrystalline cellulose, alginic acid, and the like; binders including acacia, methylcellulose, sodium carboxymethylcellulose, polyvinylpyrrolidone, hydroxypropyl methylcellulose, ethyl cellulose, and the like; and lubricants or flow agents such as magnesium stearate, calcium stearate, stearic acid, silicone fluid, talc, waxes, oils, colloidal silica, and the like. The usefulness of such excipients is well known in the art.

Nutraceutical compositions are contemplated and may be administered in combination with a nutraceutically acceptable carrier. The active ingredients in such formulations may comprise from 1% by weight to 99% by weight, or alternatively, 0.1% by weight to 99.9% by weight. “Nutraceutically acceptable carrier” means any carrier, diluent or excipient that is compatible with the other ingredients of the formulation and not deleterious to the user.

In accordance with one embodiment, a method for healthy weight gain is provided, comprising administering to an individual in need thereof a nutraceutically effective amount of a combination of a rice protein isolate, a yellow pea protein isolate, and a hemp protein isolate. The combination of a rice protein isolate, a yellow pea protein isolate, and a hemp protein isolate is a nutritional composition, dietary supplement, or functional food when provided in combination with a nutraceutically acceptable carrier. The stated weight gain suitably may be muscle mass. Weight gain and increases in muscle mass can be determined using standard physical measurements, and various useful analytical or clinical tools. One useful analytical tool is determination and calculation of PER, as discussed above.

Cereal, RTD's, and snack food formulations are preferred in the embodiments made in accordance with the present invention. The nutritional foods can be formed or shaped as desired for maximum consumer impact, nutritional efficiency, and ease of consumption and digestion.

There is a need and a desire for dietary high protein supplements and/or functional foods, including brown rice protein in combination with yellow pea protein and hemp protein, that exploit the potential beneficial properties of all three components in a readily bioavailable, consumer friendly, edible and easily consumed formulation.

Cereal is the basis of most breakfasts in the United States and elsewhere, and therefore represents an ideal choice as a nutritional or food option. RTD's are also an excellent option for people on the go, and RTD's can be consumed as substitute meals while at work or in the gym, or as protein supplements served on meal trays in hospitals, LTAC facilities, senior citizen retirement communities, or even as part of school lunches. The embodiments of the present invention also contemplate snack foods that are generally consumed by almost all modern people at various different times and places. All of the above mentioned functional food categories can provide consumer friendly, easily consumed versions of the invention.

In a particular comparison, American snack foods can produce very unhealthy consequences due to certain combinations of high fat, low protein and/or low fiber ingredients, among others. The embodiments of the present invention provide healthful, high protein, readily bioavailable options to address the profound need in our society for major lifestyle changes ranging from snack food to staple food consumption with a view toward nutritional improvement.

Various forms or shapes can be accommodated in the baked or extruded edible embodiments. Forms may be selected from the group consisting of a cereal piece, chip, flake, cluster, puff, sphere, ribbon, biscuit, chex-like shape, and O-shape. Such shapes can be formed during a manufacturing process, such as, for example, extrusion followed by automated knife-cutting. Using an extrusion process the cereal or cereal piece(s) can be formed into a variety of consumer-preferred shapes such as, but not limited to: flakes, ribbons, “chex” or “chex-like,” biscuits, or O-shapes (such as, e.g., “O's”). Other useful baked or puffed shapes include, but are not limited to: puffs, spheres, clusters, and the like.

The nutritional composition of formed foods and methods described above may be further understood in connection with the following examples.

### EXAMPLE 1

In accordance with one embodiment, a 46 g serving of hypoallergenic, high-protein breakfast cereal may include:

| | | | |
|---|---|---|---|
| a. | Brown rice flour | 23 | g (as bulk agent) |
| b. | Rice protein isolate | 2 | g |
| c. | Yellow Pea protein isolate | 8 | g |
| d. | Hemp protein isolate | 8 | g |
| e. | Oat fiber | 4 | g |
| f. | Vitamin/Mineral mix (of Table 2, below) | 1 | g |

TABLE 2

| | | |
|---|---|---|
| Vitamin A (as Beta Carotene) | 1650 | IU |
| Vitamin C (as Ascorbic Acid) | 60 | mg |
| Calcium (as Tricalcium phosphate) | 100 | mg |
| Iron (as Ferric Orthophosphate) | 6 | mg |
| Phosphorus (as Tricalcium Phosphate) | 100 | mg |
| Magnesium (as Magnesium Phosphate) | 200 | mg |
| Vitamin D3 (as Cholecalciferol) | 400 | IU |
| Vitamin E (as d-alpha-Tocopheryl Acetate) | 30 | IU |
| Vitamin B1 (as Thiamine Mononitrate) | 0.5 | mg |
| Vitamin B2 (as Riboflavin) | 0.7 | mg |
| Niacin (as Niacinamide) | 7 | mg |
| Vitamin B6 (as Pyridoxine HCl) | 7 | mg |
| Folic Acid | 200 | μg |
| Vitamin B12 (as Methylcobalamin) | 6 | μg |
| Pantothenic Acid (as Calcium d-Pantothenate) | 4 | mg |
| Zinc (as Zinc Oxide) | 5 | mg |
| Boron (as Sodium Borate) | 1 | mg |

TABLE 3

| | |
|---|---|
| Alanine | 0.97 |
| Apartic acid | 1.36 |
| Arginine | 1.29 |
| Cystine | 0.17 |
| Glutamic acid | 2.25 |
| Glycine | 0.52 |
| Histidine | 0.32 |
| Isoleucine | 0.54 |
| Leucine | 0.96 |
| Lysine | 0.80 |
| Methionine | 0.22 |
| Phenyalanine | 0.65 |
| Proline | 0.54 |
| Serine | 0.63 |
| Threonine | 0.46 |
| Tryptophan | 0.21 |
| Tyrosine | 0.47 |
| Valine | 0.66 |
| Total protein (g) | 13.03 |

As shown in Table 3, 18 g of mixed protein isolates in the present example at approx. 70-75% purity contained 13+ g of total protein. In other words, the 46 g serving contains about 13 g of protein per serving. Total protein was measure by amino acid analysis using standard methods.

Since the primary ingredients in the cereal are flour-like in texture, instead of grain-like, the cereal is cooked in a cooking extruder. This device consists of a long screw within a heated housing. First, an appropriate admixture of the above ingredients is prepared as is known in the art. (The extrusion cooking method is generally described in “Extrusion-Cooking Techniques,” ed. L. Moscicki, Wiley-VCH (2011: Weinheim, Germany), herein incorporated by reference.) The motion of the screw mixes the various flours with water, flavorings, salt, sweeteners, vitamins, minerals, and other additives or excipients. The screw moves this mixture through the extruder, cooking it as it moves along. At the end of the extruder, the cooked dough emerges as a ribbon.

Cereals or cereal piece(s) can be made in a wide variety of special shapes (circles, letters of the alphabet, etc.) with a cooking extruder. A die is added to the end of the extruder which forms a ribbon of cooked dough with the desired cross-section shape. A rotating knife cuts the ribbon into small pieces with the proper shape. These shaped pieces of dough are then placed in the “gun”, a small vessel which can hold very hot steam and very high pressure. The gun is opened quickly to reduce the pressure suddenly, which partially puffs the cereal pieces, while still allowing them to maintain their special shape. Alternatively, heat and/or pressure is applied within the extruder, and the emerging ribbon expands as it emerges into a lower pressure environment.

After shaping and/or forming, the cereal pieces may be coated with vitamins, minerals, sweeteners, flavors such as fruit juices, food colorings, or preservatives. Frosting can be applied to the cereal pieces by spraying a thick, hot syrup of sugar on the cereal in a rotating drum. As it cools the syrup dries into a white layer of frosting on to the cereal pieces. Alternatively, the process can provide a shiny, clear or semi-transparent/translucent glaze if sugar/water proportions are controlled. In general, higher concentrations of liquefied or dissolved sugar will provide higher levels of whiteness or opacity in the final cereal product.

Hot cereal versions are made by processing the cereal as above and then partly cooking it so the consumer can reconstitute it quickly in hot water in order to complete the cooking process. Salt, sweeteners, flavors, and other ingredients may or may not be added to the partly cooked mixture for pre-packaging.

### EXAMPLE 2

In accordance with another embodiment, it is expected that regular consumption of two or three servings per day of the hypoallergenic, high-protein breakfast cereal as in Example 1 would provide excellent nutritional value and sustenance to an allergic individual.

### EXAMPLE 3A

In accordance with another embodiment, a hypoallergenic, high-protein RTD dietary supplement comprising a rice protein isolate, a yellow pea protein isolate, and a hemp protein isolate is prepared using the ingredients in Table 4, as follows.

TABLE 4

| Ingredient/(Source of Manufacture) | Wt in g | Wt % |
|---|---|---|
| Pisane C9 Pea Protein Isolate (SPI Group, | 9.000 | 2.536 |
| San Leandro, California) | | |
| Oryzatein silk rice protein isolate (Axiom | 4.000 | 1.127 |
| Foods, Los Angeles California) | | |
| Hemp 70 protein isolate (Manitoba Harvest | 9.000 | 2.536 |
| Hemp Foods & Oils, Winnipeg, Canada) | | |
| Inulin fiber—Orafti Raftiline GR | 3.000 | 0.845 |
| (Orafti NA, Malvern, Pennsylavania) | | |
| Activated organic barley flour | 2.000 | 0.564 |
| (NutriTech Intl., Kristianstad, Sweden) | | |
| Tonalin 60 WDP (CLA) (Cognis Corp., | 1.500 | 0.423 |
| Ludwigshafen, Germany) | | |
| 11 Vitamin Blend WE20281 (Wright | 0.055 | 0.015 |
| Group, Crowley, Louisiana) | | |
| Nat. Choc. Flavor WONF #20321 | 2.130 | 0.600 |
| (Virginia Dare, Brooklyn, New York) | | |
| Gellan Gum—Kelcogel HS-B (CP Kelco, | 0.320 | 0.090 |
| Atlanta, Georgia) | | |
| Rice syrup base (California Natural | 172.000 | 48.464 |
| Products, Lathrop, California) | | |
| RO Water | 151.895 | 42.799 |
| Total grams per serving | 354.900 | 100.000 |

The three protein isolates are combined to form a protein isolate blend, and along with the other ingredients, are added together with the syrup base and water. Once the product is blended, sterility is achieved with an aseptic flash-heating process (temperature between 195° and 295° F. (91° to 146° C.)), which retains more nutrients and uses less energy than conventional sterilization techniques such as retort or hot-fill canning Aseptic food preservation methods allow processed food to keep for long periods of time without preservatives, as long as they are not opened. The aseptic packages are typically a mix of paper (70%), polyethylene (LDPE) (24%), and aluminum (6%), with a tight polyethylene inside layer. Together the materials form a tight seal against microbiological organisms, contaminants, and degradation, eliminating the need for refrigeration. In other words, the RTD formulations described herein may be stored at ambient temperature for extended periods of time, generally without any substantial degradation. Thus, the RTD formulations are generally shelf-stable and storable under standard conditions of temperature and pressure.

This RTD formulation is a Chocolate-flavored hypoallergenic protein RTD having an approximate (average) density=1.08 g/ml. Serving size=330 mls (354-359 g).

### EXAMPLE 3B

In accordance with another embodiment, it is expected that regular consumption of two or three servings per day of a hypoallergenic, high-protein RTD food comprising a rice protein isolate, a yellow pea protein isolate, and a hemp protein isolate in combination with a nutraceutically acceptable carrier and an edible liquid as in Example 3A, made in accordance with the principles of the invention would provide excellent nutritional value and sustenance to an allergic individual.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

All references cited herein are incorporated by reference in their entirety. The present invention may be embodied in other specific forms without departing from the spirit or essential attributes thereof and, accordingly, reference should be made to the appended claims, rather than to the foregoing specification, as indicating the scope of the invention.

I claim:

1. A formed food composition comprising a protein isolate blend including a rice protein isolate, a yellow pea protein isolate, and a hemp protein isolate in combination with a nutraceutically acceptable carrier having a form selected from the group consisting of a cereal piece, chip, flake, cluster, puff, sphere, ribbon, biscuit, chex-like shape, and O-shape.

2. The formed food composition of claim 1, wherein the rice protein isolate is present in a range of from about 1 g to about 12 g per serving, the yellow pea protein isolate is present in a range from about 3 g to about 15 g per serving, and the hemp protein isolate is present in a range from about 3 g to about 15 g per serving.

3. A hypoallergenic food composition comprising a protein isolate blend including a rice protein isolate, a yellow pea protein isolate, and a hemp protein isolate in combination with a nutraceutically acceptable carrier, having the form of a cereal piece, chip, flake, cluster, puff, sphere, ribbon, biscuit, chex-like shape, or O-shape, wherein said food is administered orally.

4. The hypoallergenic food composition of claim 3, wherein the rice protein isolate is present in a range of from about 1 g to about 12 g per serving, the yellow pea protein isolate is present in a range from about 3 g to about 15 g per serving, and the hemp protein isolate is present in a range from about 3 g to about 15 g per serving.

5. The hypoallergenic food composition of claim 4, further comprising oat fiber and a vitamin/mineral mixture.

6. The hypoallergenic food composition of claim 5, wherein a serving comprises:

| | |
|---|---|
| brown rice flour | 23 g, |
| rice protein isolate | 2 g, |
| yellow pea protein isolate | 8 g, |
| hemp protein isolate | 8 g, |
| oat fiber | 4 g, and |
| vitamin/mineral mix | 1 g. |

7. The hypoallergenic food composition of claim 6, wherein the vitamin/mineral mix comprises:

| | | |
|---|---|---|
| Vitamin A (as Beta Carotene) | 1650 | IU |
| Vitamin C (as Ascorbic Acid) | 60 | mg |
| Calcium (as Tricalcium phosphate) | 100 | mg |
| Iron (as Ferric Orthophosphate) | 6 | mg |
| Phosphorus (as Tricalcium Phosphate) | 100 | mg |
| Magnesium (as Magnesium Phosphate) | 200 | mg |
| Vitamin D3 (as Cholecalciferol) | 400 | IU |
| Vitamin E (as d-alpha-Tocopheryl Acetate) | 30 | IU |
| Vitamin B1 (as Thiamine Mononitrate) | 0.5 | mg |
| Vitamin B2 (as Riboflavin) | 0.7 | mg |
| Niacin (as Niacinamide) | 7 | mg |
| Vitamin B6 (as Pyridoxine HCl) | 7 | mg |
| Folic Acid | 200 | μg |
| Vitamin B12 (as Methylcobalamin) | 6 | μg |
| Pantothenic Acid (as Calcium d-Pantothenate) | 4 | mg |
| Zinc (as Zinc Oxide) | 5 | mg |
| Boron (as Sodium Borate) | 1 | mg. |

8. The hypoallergenic food composition of claim 6, wherein the protein isolate blend contains at least about 13 g total protein.

9. The hypoallergenic food composition of claim 5, which is made by extrusion cooking

10. A hypoallergenic dietary supplement composition comprising a protein isolate blend including a rice protein isolate, a yellow pea protein isolate, and a hemp protein isolate in combination with a nutraceutically acceptable carrier and an edible liquid in a ready-to-drink formulation.

11. The hypoallergenic dietary supplement composition of claim 10, wherein the rice protein isolate is present in a range of from about 1 g to about 12 g per serving, the yellow pea protein isolate is present in a range from about 3 g to about 15 g per serving, and the hemp protein isolate is present in a range from about 3 g to about 15 g per serving.

12. The hypoallergenic dietary supplement composition of claim 10, wherein the edible liquid comprises a rice syrup base.

13. The hypoallergenic dietary supplement composition of claim 11, wherein the protein isolate blend contains at least about 13 g total protein.

14. A method of making a hypoallergenic dietary supplement composition in a ready-to-drink (RTD) form, comprising the steps of:
(a) combining a rice protein isolate, a yellow pea protein isolate, and a hemp protein isolate to form a protein isolate blend;
(b) adding an edible liquid to the protein isolate blend to form a suspension;
(c) sterilizing the suspension using aseptic flash heating between about 90° C. and about 150° C.; and
(d) sealing the sterilized suspension in a package or container to provide a finished dietary supplement composition.

15. The method of claim 14, wherein the rice protein isolate is present in a range of from about 1 g to about 12 g per serving, the yellow pea protein isolate is present in a range from about 3 g to about 15 g per serving, and the hemp protein isolate is present in a range from about 3 g to about 15 g per serving.

16. The method of claim 14, wherein the edible liquid comprises a rice syrup base.

17. A ready-to-drink (RTD) hypoallergenic dietary supplement made according to the method of claim 14.

18. The ready-to-drink (RTD) hypoallergenic dietary supplement of claim 17 which is stable at ambient temperature.
